(19) United States
(12) Patent Application Publication
(10) Pub. No.: US 2026/0139638 A1
(43) Pub. Date: May 21, 2026

(54) METHOD AND APPARATUS FOR DISPENSING FUEL

(71) Applicant: Transportation IP Holdings, LLC, Norwalk, CT (US)

(72) Inventors: Christopher Joseph Homison, Wattsburg, PA (US); Gregory Wright, Longmont, CO (US)

(73) Assignee: Transportation IP Holdings, LLC, Norwalk, CT (US)

(21) Appl. No.: 18/951,449

(22) Filed: Nov. 18, 2024

(51) Int. Cl. F02D 41/26; F02D 41/00

(52) U.S. Cl. CPC F02D 41/263; F02D 41/0027; F02D 2200/0602; F02D 2200/0606

(57) ABSTRACT

A method is provided for determining a supply status of a fuel supply system for delivering fuel to a power generator. The method includes generating an energy plan for the power generator based at least in part on a supply status of fuel in the fuel supply system, and selectively adjusting an operating parameter of the fuel supply system based at least in part on the energy plan is disclosed. The power generator and the fuel supply system can store a cryogenic fuel and to handle gasified fuel obtained therefrom. A method and a system for a vehicle having a power generator and a fuel supply system are also disclosed.

### BACKGROUND

### Technical Field

The subject matter described herein relates to systems and methods for dispensing fuel.

### Discussion of Art

Fuel converters may produce useful work from chemical energy contained in fuels, some of which may require special storage conditions. For example, hydrogen and/or natural gas based fuel may be stored at low or cryogenic temperatures as liquefied fuels having high energy density. However, the storage condition of liquefied fuels may require further energy intensive preparation prior to being consumed by a fuel converter. Additionally, systems for delivering fuels stored at cryogenic temperatures may be limiting with respect to the rate at which fuel may be consumed by fuel converters. Thus, it may be desirable to coordinate operations of fuel converters and fuel supply systems.

### BRIEF DESCRIPTION

In a first embodiment, a method includes determining a supply status of a fuel supply system that is configured to deliver fuel from a fuel storage to a power generator, generating an energy plan for the power generator based at least in part on the supply status, and selectively adjusting an operating parameter of the fuel supply system based at least in part on the energy plan.

In one aspect of the first embodiment, determining a supply status of the fuel supply system includes measuring a pressure, a temperature, or both within the fuel storage.

In another aspect of the first embodiment, determining a supply status of the fuel supply system includes determining an amount of liquid fuel within the fuel storage.

In another aspect of the first embodiment, determining the supply status includes determining an amount of gaseous fuel available, as a volume, weight or energy content of fuel based on one or both of an amount of liquid fuel and a pressure of a gaseous fuel.

In another aspect of the first embodiment, the supply status includes at least one of a current fuel supply status a forecasted fuel supply status, a current pressure of a gaseous fuel fraction in the fuel storage, a forecasted pressure of a gaseous fuel fraction in the fuel storage, a current consumption rate of fuel by the power generator, or a forecasted consumption rate of fuel by the power generator.

In another aspect, which can be combined with one or more of the previously recited aspects of the first embodiment, determining the supply status includes determining a remaining lifetime of fuel stored within the fuel storage of the fuel supply system based at least in part on one or more of a current operating pressure of the fuel supply system, a forecast operating pressure of the fuel supply system, a current consumption rate of fuel by the power generator, a forecast consumption rate of fuel by the power generator, or a venting pressure threshold of the fuel supply system.

In another aspect, which can be combined with one or more of the previously recited aspects of the first embodiment, the method further includes feeding fuel from the fuel storage to an auxiliary fuel converter based on the supply status indicating a current operating pressure of the fuel supply system exceeds a determined pressure threshold value in the fuel storage.

In another aspect, which can be combined with one or more of the previously recited aspects of the first embodiment, the method further includes feeding fuel from the fuel storage to an auxiliary fuel converter responsive to the supply status indicating a forecasted operating pressure of the fuel supply system exceeds a determined pressure threshold value in the fuel storage.

In another aspect, which can be combined with one or more of the previously recited aspects of the first embodiment, feeding fuel from the fuel storage to an auxiliary fuel converter is further responsive to a state of charge of an electrical energy storage device.

In another aspect, which can be combined with one or more of the previously recited aspects of the first embodiment, the operating parameter of the fuel supply system comprises a pressurization rate, a vaporization rate, a heat transfer flow rate, a flow control operation, a regasification rate, a recirculation rate, a recondensation rate, or a combination of two or more thereof.

In another aspect of the first embodiment, the power generator is one of a plurality of prime movers and the energy plan includes a workload distribution between each of the plurality of prime movers. The workload distribution is based at least in part on at least one of an aggregate power output or an aggregate energy output of the plurality of prime movers.

In another aspect, which can be combined with one or more of the previously recited aspects of the first embodiment, the method further includes adjusting the operating parameter for feeding fuel from the fuel storage to a first prime mover and to a second prime mover of the plurality of prime movers and the operating parameter is adjusted based at least in part on the workload distribution.

In another aspect, which can be combined with one or more of the previously recited aspects of the first embodiment, each prime mover is a fuel cell, and the method further includes operating each fuel cell in a determined range of efficiency, as demand for aggregate power or aggregate energy increases, a new prime mover is not activated or provided fuel until each operating prime mover is operating at or near a top end of its determined range of efficiency.

In another aspect, which can be combined with one or more of the previously recited aspects of the first embodiment, all of the operating prime movers are adjusted to the lower end of their determined range of efficiency in response to bringing an additional prime mover online.

In a second embodiment, a method includes determining a supply status that is associated with an operation of a cryogenic fuel supply, determining an expected operation of the vehicle along a route and a determined fuel need by the prime mover, and switching an operating mode of at least one of the cryogenic fuel supply or the prime mover in response to the determined supply status. The cryogenic fuel supply is configured to feed a prime mover of a vehicle. The determined fuel need is associated with the expected operation as the vehicle traverses the route.

In one aspect of the second embodiment, determining the supply status includes obtaining a transition time of fuel from a first state and a second state, and switching an operating mode of at least one of the cryogenic fuel supply or the prime mover includes increasing or decreasing a rate of transition of fuel in response to the determined fuel need.

In another aspect, which can be combined with one or more of the previously recited aspects of the second embodiment, a transition time of fuel from a first state and a second state is about static, and switching an operating mode of at least one of the cryogenic fuel supply or the prime mover includes offsetting an initiation of the transition to meet an expected increase or decrease in determined fuel need of the prime mover.

In another aspect, which can be combined with one or more of the previously recited aspects of the second embodiment, a transition time of fuel from a first state and a second state is about static, and switching an operating mode of at least one of the cryogenic fuel supply or the prime mover includes reducing an expected power requirement from the prime mover.

In a third embodiment, a system for a vehicle includes a control circuit. The vehicle has a power generator and a fuel supply system for delivering fuel to the power generator. The control circuit is configured to determine a forecasted supply status that is associated with an operation of the fuel supply system, determine an expected operation of the vehicle along a route, determine a forecasted fuel need by the power generator, and switch an operating mode of the fuel supply system or the power generator in response to match the forecasted supply status with the forecasted fuel need. The fuel supply system is configured to feed the power generator. The forecasted fuel need by the power generator is associated with the expected operation as the vehicle traverses the route.

In one aspect of the third embodiment, the fuel has an adjustable transition time from a first state and a second state, and the control circuit in switching the operating mode is further configured to, one or more of: adjust the transition time of the fuel to adjust the transition time in response to the forecasted fuel need; offset an initiation of a transition of the fuel in response to the forecasted fuel need; reduce a power output of the power generator; or reduce a speed of the vehicle.

### BRIEF DESCRIPTION OF DRAWINGS

Reference is made to the accompanying drawings in which similar components are indicated using the same reference numbers, and in which:

FIG. 1 is a diagram of a system in accordance with at least one aspect of the disclosure.

FIG. 2 is a diagram of a fuel supply system in accordance with at least one aspect of the present disclosure.

FIG. 3 is a graph depicting efficiency relative to power output in accordance with at least one aspect of the present disclosure.

FIG. 4 is a graph depicting efficiency relative to power output in accordance with at least one aspect of the present disclosure.

FIG. 5 is a flow diagram of a method in accordance with at least one aspect of the present disclosure.

FIG. 6 is a flow diagram of a method in accordance with at least one aspect of the present disclosure.

### DETAILED DESCRIPTION

The present disclosure provides systems and methods for dispensing fuel. The system may coordinate an operation of a fuel supply system with an operation of a power generator. The power generator can be a fuel converter, which converts chemical energy of a fuel to mechanical and/or electrical energy. A fuel converter, such as a fuel cell for hydrogen fuel, may require fuel in a gaseous and/or vaporized (liquid) state. As used herein, the term “fuel” may refer to a substance which may be utilized as a source of energy and may not be limited to any particular physical state unless specified. For example, the unmodified term “fuel” is inclusive of liquid fuel, gaseous fuel, vaporized fuel, or a mixture thereof. The term “gasified fuel” as used herein may include, but not be limited to, gaseous fuel obtained from fuel in a non-vapor state such as a liquid stored at cryogenic temperatures.

The energy density of a fuel may determine its viability in cases where vehicle weight, distance, or mobility is of greater import. Some applications impacted by fuel density may include transportation systems where space and/or fuel capacity may be limited. Liquid fuels are sometimes more energy dense than gaseous fuels. In the context of certain volatile fuels, such as natural gas and hydrogen, initial storage thereof may include charging a storage volume with fuels in a liquid state and/or condensing gaseous fuels therein prior to being ready for use. The liquid state is sometimes at cryogenic temperature levels. And, due to the thermophysical properties thereof, the vapor pressure may rise responsive to increased temperatures. This may complicate storage of liquid fuel container at ambient conditions, particularly if the container is not used or depleted in a timely manner. The vapor pressure may continue to increase, and at a determined level of pressure may need to be drawn down or vented as a pressure relief response.

Furthermore, the maximum allowable storage pressure of a storage volume may be limited to comply with a design pressure rating thereof and/or transportation regulations. The temperature and/or pressure of stored fuel may change over time. The amount of change may be based at least in part on factors such as cooling capacity of a temperature control system, a fuel storage volume, amount of fuel stored, fuel type and fuel specific parameters, usage rates, thermal insulation capabilities, and/or environmental conditions. Ambient conditions may include ambient temperature and atmospheric pressure surrounding the storage volume. As such, the storage pressure may increase (through vaporization) until it exceeds a specified pressure limit, pressure threshold value. Once the pressure threshold value for the system has been exceeded the system may respond by expelling or venting the vapor/gas fraction of the fuel from the storage volume. This may continue until there is a return of fuel storage conditions to be within the determined pressure range. Thus, the stored fuel may not remain in dormant state indefinitely. As used herein, the term “dormancy” refers to a duration of time available for fuel to remain in storage until a measured parameter (e.g., gage pressure) in a storage volume exceeds a specified threshold (e.g., pressure limit). Various embodiments involve coordinating operation of a fuel supply system and a power generator to efficiently utilize stored fuel and/or meet power demands based on fuel supply dormancy.

In one embodiment, a fuel supply system may deliver fuel to a power generator. The fuel supply system may define a storage volume. The storage volume can contain an amount of fuel. The fuel may be supplied via the fuel supply system to the power generator. The fuel, while in the storage volume, may have at least a fraction that is in a liquid and/or dense state. The system may include a fuel operation unit, which may perform a preparative operation on fuel within the fuel supply for the purposes of preparing and/or facilitating delivery of fuel to the power generator. The term “fuel supply” may refer to a fuel which is a precursor, in the physical but not chemical sense, to fuel suitable, or otherwise more suitable than the fuel supply itself, for immediate consumption by a power generator, such as gasified fuel. For example, in the context of a fuel cell, the fuel operation unit may add thermal energy to a hydrogen fuel supply in the form of a cryogenic liquid, which may gasify and/or heat the fuel supply to obtain gasified hydrogen fuel therefrom, and/or pressurize the fuel supply which may provide a suitable driving force for feeding fuel to the power generator. Alternatively, or additionally, the fuel operation unit may prepare the fuel supply for a standby operation which may include removing thermal energy from the fuel supply. A fuel supply status of the fuel supply system and a supply status of fuel within the fuel supply system may be used to generate an energy delivery plan.

A fuel control circuit for the fuel supply system may determine a supply status associated with the fuel supply system, determine a fuel parameter associated with an operation on the fuel supply, and/or adjust an operating parameter or operating mode of the fuel supply system. The fuel control circuit may include one or more sensors, which may include temperature and/or pressure sensors, disposed in one or more determined portions of the fuel supply system, such as in a storage volume for the fuel supply, a fuel operation unit, or a conduit for flowing fuel to or from the fuel supply system.

The power generator may be a fuel converter for generating electrical energy from fuel originating from the fuel supply system. In an embodiment, the power generator may be a prime mover supported on a vehicle for traversing a route, such as a locomotive. The prime mover may be supported on a vehicle having one or more electric traction motors. The prime mover, which may be a fuel cell, may be electrically coupled to the one or more electric traction motors and operated to supply electrical power for the one or more traction motors. Additionally, or alternatively, the prime mover may be an internal combustion engine. The prime mover and the one or more traction motors may form at least a portion of a power system. The efficiency of a prime mover can be determined based on a comparison of an amount of fuel, and/or chemical energy content thereof, consumed by the prime mover and an amount of electrical energy converted from the fuel. The prime mover may additionally be electrically connected to a charging system to charge a battery which may power a traction motor or another auxiliary electrical device and/or store electrical energy for later use.

A power control circuit for the prime mover may adjust an operation of the prime mover at a determined efficiency setting, such as an efficiency at or near a top end of a determined range of efficiency, to meet a power or energy demand and to activate one or more additional prime movers until the power demand has been met. The determined efficiency can be set to be a desired level, such as equal to or greater than 90 percent efficiency in converting a chemical energy of a fuel to electrical energy.

The amount and/or rate of fuel consumed by the prime mover along a route can be responsive to one or more travel factors, or changes thereof. Travel factors can include geographical conditions, such as grade and/or elevation, vehicle conditions, such as vehicle speed, vehicle weight, and/or cargo loading on the vehicle, weather conditions, and/or route conditions which may include static, or low variability, conditions such as route curvature, route travel surface conditions, and/or posted speed restrictions. Route conditions can also include situational conditions, such as, for example, traffic and/or accidents along the route, which may be more variable than the aforementioned static conditions. In one embodiment, the power control circuit is communicatively coupled to a control circuit of a transportation control system which may include a transportation processor that performs calculations associated with fuel consumption, such as a determined fuel requirement of a prime mover to meet a determined power demand and/or operating efficiency, some of which may be predictive with respect to expected changes in travel factors and/or expected operations in consideration thereof. Thus, the power control circuit may adjust an operation of one/or more prime movers based on forecasted changes in travel factors. However, certain forecasted changes may be assigned more weight than others when implemented to determine the expected operational change for the power prime mover based on the variability of travel factors utilized and extent of forecasting with respect to time.

The fuel control circuit may be communicatively coupled to other control circuits, such as the power control circuit for a power generator. Alternatively, or additionally, both the fuel control circuit and the power control circuit can be communicatively coupled to a control circuit of a transportation control system for a vehicle having the power generator and the fuel supply system, which may deliver fuel to the power generator. In an embodiment, the control circuit of the transportation control system may be configured to determine a fuel parameter that is associated with an operation of a cryogenic fuel supply that is fed the power generator, determine an expected operation of the vehicle along a route and a determined fuel need by the power generator associated with the expected operation as the vehicle traverses the route, and switch an operating mode of at least one of the cryogenic fuel supply or the power generator in response to the determined fuel parameter.

These systems may be useful for energy management in a transportation system that may include a single vehicle supporting a prime mover or may be a group formed of a plurality of vehicles, such as a consist. An example of a suitable vehicle may be a rail vehicle. A suitable rail vehicle may be a locomotive equipped with at least one power system for propelling a consist, including a fuel cell system having one or more fuel cells.

A consist may include a plurality of locomotives, each supporting a dedicated prime mover. For example, the consist may include a first locomotive positioned at or near a leading end of a consist and a second locomotive positioned at or near a trailing end of the consist and one or more fuel supply storage volumes for feeding the prime movers. The one or more fuel supply storage volumes may be supported on one or more of the locomotives, and/or on one or more dedicated fuel tender vehicles. In an embodiment, the consist can include other types of power generators and/or prime movers such as an internal combustion engine, which may also be fed by the one or more fuel supply storage volumes or otherwise interact with the fuel supply system, such as, for example, by providing waste heat to operate a heat exchanger of a fuel operation unit. In other embodiments, combinations of power devices including power generators may be implemented at the locomotives, such as a locomotive equipped with a fuel cell and a battery, a locomotive equipped with an engine and a fuel cell, and/or a locomotive equipped with a battery and an engine. Various combinations are possible but an energy plan for energy and/or fuel management amongst the consist vehicles may be similarly applied, as described herein.

An energy plan may include coordinating, by a transportation control system, operation of the fuel supply system and the prime movers to maximize an overall system efficiency of the transportation system. This may be done while optimizing fuel use during a trip. Optimization of fuel use may be accomplished by minimizing fuel waste and/or maximizing use of fuel. Fuel waste may be minimized by adjusting fuel supply operation based on determined supply status or states thereof, which may include optimizing fuel delivery based on dormancy. Maximizing fuel efficiency may include utilizing for auxiliary purposes an amount of fuel within the fuel supply that is in excess of an amount of fuel required for completing a trip. Auxiliary purposes may include generating electricity to charge a battery or run a hotel load, and the like.

The power control circuit may operate a prime mover within a target efficiency range, which may be determined according to an amount of fuel available for use. Workload, e.g., an amount of power demanded to provide a desired power output, may be distributed amongst the prime movers to enable operation of each prime mover at high efficiency, manage dormancy times of one or more fuel supplies, and/or meet an aggregate power demand while minimizing fuel consumption rate. Adjustment of workload distribution and/or aggregate power demand along a route may rely on the energy plan. This energy plan may designate or dictate operational settings of the fuel supply system and the prime movers at different times, locations, distances along routes, or the like, to reach one or more goals (e.g., efficiency of) subject to one or more constraints, e.g., minimizing fuel waste and/or maximizing use of fuel. Forecasted changes in travel factors as described hereinabove may be utilized to determine suitable operation of the prime movers. In an embodiment, the transportation control system may determine an energy plan for a trip along a route based at least on travel factors, a supply status associated with the fuel supply, and an expected operation of a power generator fed by the fuel supply system during the route.

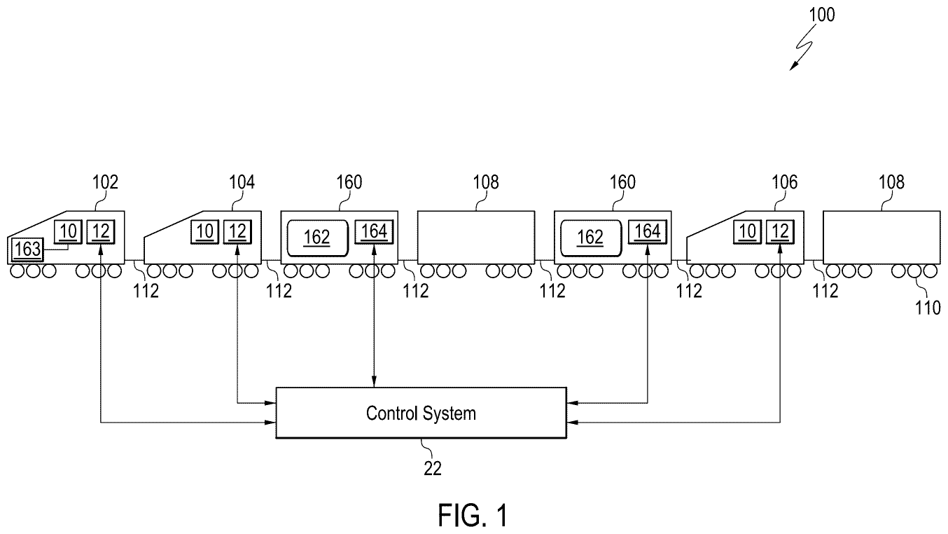

FIG. 1 depicts an a transportation system including a vehicle group 100, in accordance with at least one aspect of the present disclosure. The vehicle group 100 includes a plurality of rail vehicles 102, 104, 106, fuel tender vehicles 160 and cars 108. The plurality of rail vehicles, the fuel tender, and the cars may be mechanically coupled, communicatively coupled, or both, via couplers 112. In some cases, certain vehicles may also be electrically coupled, fluidly coupled, or both as described in greater detail below. In one embodiment, the plurality of rail vehicles may be locomotives, including a lead locomotive and one or more remote locomotives. While the depicted embodiment shows three locomotives and four cars, any appropriate number of locomotives and cars may be included in the vehicle group. Various vehicle types may form various types of vehicle groups, such as consists, convoys, swarms, fleets, platoons, and the like.

In some examples, the vehicle group may include successive locomotives, e.g., where the locomotives are arranged sequentially without cars positioned in between. In other examples, as illustrated in FIG. 1, the locomotives may be separated by one or more cars in a configuration enabling distributed power operation. In this configuration, throttle and braking commands may be relayed from the lead locomotive to the remote locomotives by a radio link or physical cable, for example. The lead locomotive may communicate with wayside devices, and in some examples therethrough to back office systems, to determine whether they have one or more of movement authority, movement restrictions, speed limits, noise or emission limits, and the like.

The locomotives may be powered by a power system including a prime mover 10, which may be a fuel cell in one embodiment, as well as an internal combustion engine, and/or a combination thereof, in other embodiments, and a battery. The cars may be unpowered. A suitable prime mover may be a fuel cell or a plurality of fuel cells, the number and selection of such fuel cells may be made with reference to end use requirements and available fuel cell capacity and technology. As fuel cell power output capability increases, fewer fuel cells may be necessary to achieve a sufficient total power output. Fuel cells may be proton exchange membrane (PEM) type, solid oxide fuel cell (SOFC) type, or other, selected with reference to end use requirements. In one embodiment, a suitable fuel for a fuel cell and/or an internal combustion engine may include volatile fuels such as hydrogen and/or natural gas. The hydrogen fuel may be gasified fuel.

As depicted in FIG. 1, each prime mover may be communicatively coupled to a power control circuit 12, each of which may additionally be communicatively coupled to a control circuit of transportation control system 22. The transportation control system may receive data associated with signals originating from a variety of sensors on one or more of the vehicles and cause at least one of the power control circuits to adjust an operating mode of the respective prime mover accordingly. The transportation control circuit may be located on one vehicle of the vehicle group, such as the lead locomotive, or may be remotely located, for example at a dispatch center.

The vehicle group may include one or more fuel tenders 160, which may support one or more portions of a fuel supply system. The fuel supply system may include one or more storage volumes 162 and be controlled by a fuel control circuit 164, such as on multiple fuel tenders as depicted in FIG. 1. While the fuel tenders illustrated in FIG. 1 are positioned between remote locomotives, other embodiments may include alternate locations of the fuel tender along the vehicle group. For example, one or more fuel tenders may be instead positioned behind the remote locomotive or between the lead locomotive and the remote locomotive.

The storage volume may store fuel as a fuel supply. In some embodiments, fuel may be stored only at the fuel tender. In other embodiments, fuel may be stored both at the fuel tender and in an auxiliary storage volume at one or more of the locomotives, which may only store gaseous fuels. In one embodiment, fuel may be stored in a storage volume as a fuel supply and in an auxiliary storage volume as a fuel obtained from the fuel supply.

The fuel tender may be un-powered, e.g., without electric traction motors. However, in other implementations, the fuel tender may include a power system including a power generator, such as a fuel cell, which may deliver electrical power to an electrical storage device supported on the fuel tender or to an electric traction motor on the fuel tender or another vehicle.

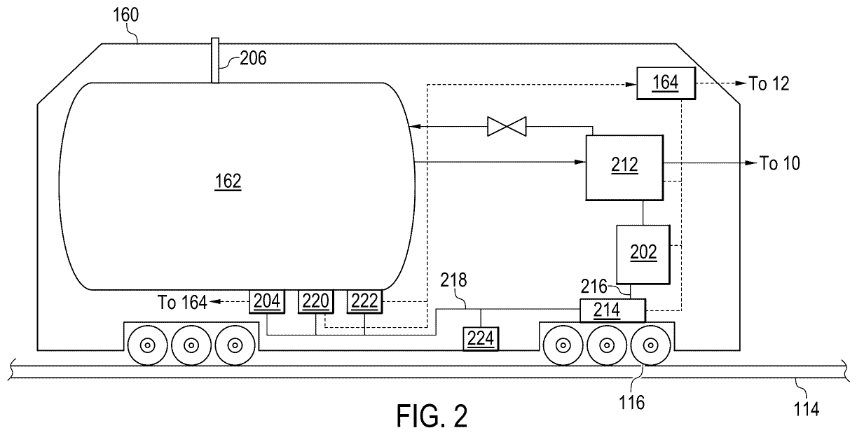

The storage volume may have a suitable structure for storing a specific type of fuel as a fuel supply. In one embodiment, the storage volume may be configured for storage of liquefied natural gas (LNG) or liquefied hydrogen, which may be at cryogenic temperatures. Alternatively, the storage volume may be used to store a fuel in a liquid state at ambient temperature and pressure, such as diesel or ammonia, or a fuel as a compressed gas, such as hydrogen or natural gas. In each instance, the fuel tender may be equipped with various mechanisms and devices for storage of the particular fuel. Further details of the fuel tender are shown further below, with reference to FIG. 2.

Turning now to FIG. 2, an embodiment of the fuel tender of FIG. 1 is shown. As described above, the fuel tender may support a fuel supply system including a storage volume, and a fuel control circuit. The fuel supply system may further include a fuel maintenance unit 204, which may be a device for controlling a temperature and pressure within the fuel storage reservoir. For example, when a volatile fuel such as hydrogen is stored in the storage volume, the first fuel operation unit may include a cooler, a cryogenic device, a vapor layer bleed off device, a pressure safety release device, a leak detection device, and the like. The capacity of the fuel storage volume and operations may be selected based on end use parameters, may be removable from the fuel tender, and may be receive fuel from an external refueling station via port 206. The fuel supply system may also include instrumentation for monitoring a fuel supply liquid level in the storage volume such as a level sensor, which may be a float switch device, a capacitance device, or an ultrasonic device, or a pressure device such as a differential pressure transmitter that compares pressures between a top portion and a bottom portion of the storage volume.

The storage volume may be in fluid communication with at least one fuel operation unit 212, which may be a heat exchanger. The fuel operation unit may adjust a characteristic of the fuel supply via exchanging thermal energy therewith. For example, the fuel operation unit may be a gasifier which may convert the fuel supply from a liquid phase to a gas phase. As another example, the fuel operation unit may be a pressurizing unit to adjust a pressure within the storage volume to a greater pressure suitable for driving a flow from the fuel supply to a locomotive of interest to feed a prime mover thereon. The pressurizing unit may vaporize an amount of fuel stored in the storage volume at a first pressure to produce a pressurized fuel at a pressure greater than the first pressure and reinject the pressurized fuel back into the storage volume.

The fuel operation unit may perform multiple duties. In one embodiment, the fuel operation unit may obtain gasified fuel from the fuel supply and maintain the fuel supply in the storage volume at a driving pressure. In this embodiment, the fuel operation unit may include a first heating stage for gasifying and a second heating stage for pressurizing. A first portion of the fuel flowing through the fuel operation unit may be fed to a fuel converter as gasified fuel and a second portion of the fuel may be returned to the storage volume as pressurized fuel, which may also be in a gaseous state. Thus, a delivery of gasified fuel from the fuel supply system may be pressure-driven, thereby avoiding the use of liquid pumps which may present issues when used with cryogenic fuels. The fuel operation unit may also include flow valves at any of the inlets and outlets thereof, which may be controlled and/or actuated by the fuel control circuit as needed to adjust an operation on the fuel supply in the storage volume.

By feeding fuel from the storage volume to a prime mover, the fuel may be converted to electrical power. In another non-limiting embodiment, the fuel tender may include a power system including a power generator 202, which may generate electricity for use by one or more components on-board the fuel tender and/or on-board the locomotives. In one example, as depicted in FIG. 2, the fuel converter may transmit electricity to a power conversion unit 214 via a DC bus 216. The power conversion unit may convert the electrical energy from DC to AC, which is delivered via an AC electrical bus 218 to a variety of downstream electrical components in the fuel tender. Such components may include, but are not limited to a communication device, the fuel operation unit, the fuel control circuit, a pressure sensor 220, a temperature sensor 222, batteries 224, various valves, flow meters, compressors, blowers, radiators, lights, on-board monitoring systems, displays, climate controls, and the like, some of which are not illustrated in FIG. 2 for brevity. Additionally, electrical energy from the electrical bus may be provided to one or more components of the locomotives.

Based on a downstream electrical component receiving DC power from the electrical bus, one or more inverters may invert the electrical power from the electrical bus prior to supplying AC electrical power to the downstream component. In one example, a single inverter may supply AC electrical power from a DC electrical bus to a plurality of components. In another non-limiting embodiment, each of a plurality of distinct inverters may supply electrical power to a distinct component.

The fuel control circuit may control various components associated with the fuel supply system, such as the fuel operation unit, control valves, and/or other components on-board the fuel tender, by sending commands to such components. The fuel control circuit may also monitor fuel parameters of the fuel supply system in active operation, idle and shutdown states. Such fuel parameters may include, but are not limited to, fuel supply variables such as the pressure and temperature of the fuel storage volume and/or liquid level in the storage volume, a pressure and temperature of the fuel operation unit, the fuel tender fuel converter temperature, pressure, and load, compressor pressure, heating fluid temperature and pressure, ambient air temperature, heat capacity, and the like. Additional fuel supply operating parameters, some of which may be determined and/or derived from the aforementioned fuel parameters, may include storage volume pressurization and/or depressurization rates, vaporization rates, heat transfer flow rates, aggregate feed rates to power generators, and vapor/liquid proportions, at various portions of the fuel supply system.

In an embodiment, the transportation control system may receive and/or access fuel parameters from the fuel control circuit. Based on at least one of the fuel parameters, the transportation control system may determine a supply status of the fuel supply system and/or fuel in a determined portion of the fuel supply system. The supply status may include a value of a fuel parameter and/or a status derived therefrom, such as fuel supply dormancy, storage volume fill state, energy content of a fuel supply, an amount of fuel which may be readily delivered, flow capacity, fuel supply readiness, cryogenic fuel supply status, consumption rate of fuel, or a forecasted status based on a current supply status.

In one example, the fuel control circuit may execute code to auto-stop, auto-start, operate and/or tune the fuel operation unit in response to one or more control system routines. The computer readable storage media may execute code on processors, provided for that purpose, to transmit to and receive communications from communication devices on-board the locomotives. The processors can be hardware circuitry that includes and/or is connected with one or more integrated circuits, microprocessors, field programmable gate arrays, or the like.

The fuel tender depicted in FIG. 2 is a non-limiting example of a configuration of the fuel tender. In other examples, the fuel tender may include additional or alternative components. As an example, the fuel tender may further include one or more additional sensors, flow meters, control valves, various other devices and mechanisms for controlling fuel delivery and storage conditions, etc.

As described above, a transportation system, such as a vehicle group, may include multiple power systems for propulsion. Each power system may include one or more power devices, such as an engine, a battery, and at least one fuel cell (i.e., fuel cell module), respectively. When power is regularly drawn from the power system at maximum power capacity, such as during operation at high loads, a power system may be used under conditions outside of its optimal operating range. As one example, frequent cycling of a battery between full charge and charge depletion at high charge/discharge rates may accelerate loss of cycling capacity. Operation of a fuel cell system at maximum power generation may degrade a performance of a fuel cell module at a faster rate. As a result, a useful life of such power systems may be curtailed, leading to more frequent maintenance and replacement.

In one example, the issues described above may be at least partially addressed by strategically operating the power systems in a coordinated manner to enable each power system to be operated according to a high efficiency output. The high efficiency output may represent operation of the prime mover at load levels facilitating power provision with minimal losses, preservation, and prolonging of a performance of the power system, as well as enabling a power demand to be met while minimizing release of carbon-based emissions. Furthermore, in some instances, a determined trip plan, as stored at a control circuit such as the power control circuit, fuel control circuit and/or transportation control system, may be used to optimize operation of the power systems while accounting for the individual operating characteristics of the power systems.

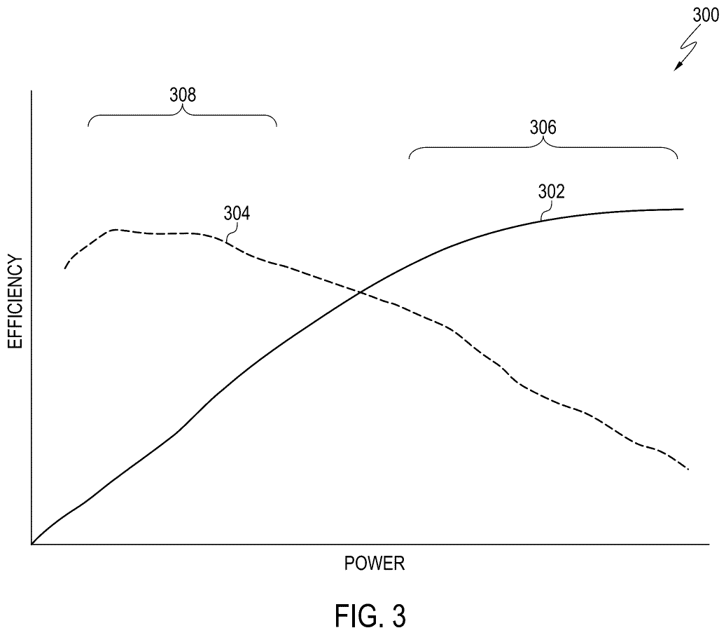

An efficiency of the power systems may demonstrate different dependencies on load. For example, an amount of power provided by a battery may depend on a discharge rate of the battery, and therefore does not exhibit variations in efficiency according to power. A battery's life may be affected by the depth, rate of discharge, and frequency of the charge and discharge of the battery. In contrast, operation of the prime movers both of a fuel cell and an engine at their respective maximum efficiencies may correspond to specific and different power output ranges. Efficiencies of an engine and a fuel cell is shown in FIG. 3 in a graph 300 depicting efficiency (e.g., percent efficiency) relative to power output. Efficiency increases upward along the y-axis and power output increases to the right along the x-axis.

Efficiency of the respective power system may exemplify operation of the power system with minimal losses (e.g., electrical and/or mechanical). The graph includes a first plot 302, representing an efficiency curve of an engine, e.g., an internal combustion engine, and a second plot 304, representing an efficiency curve of a fuel cell. A high efficiency range, e.g., efficiencies above a first threshold efficiency such as 40%, of the engine relative to power output is indicated by region 306, and a high efficiency range of the fuel cell, e.g., efficiencies above a second threshold efficiency such as above 50%, relative to load level is indicated by region 308. The high efficiency range of the engine may correspond to a power output range of about 70%-100% of a rated power of the engine and the high efficiency range of the fuel cell may correspond to a power output range of about 20%-40% of a rated power of the fuel cell.

As shown in the graph, the high efficiency range of the engine occurs at high power output while the high efficiency range of the fuel cell occurs at low power output, e.g., lower than the high efficiency range of the engine. As such, each of the battery and the fuel cell may be preferentially operated at their respective high efficiency ranges when allowable based on an overall power demand for operation of a vehicle group. Operation of the fuel cell at the high efficiency range (e.g., low-mid power output/load) may extend a life of the fuel cell. If present in a consist, a battery may be used to provide supplementary power when a combined power output resulting from high efficiency operation of the fuel cell and the battery falls short of the overall power demand.

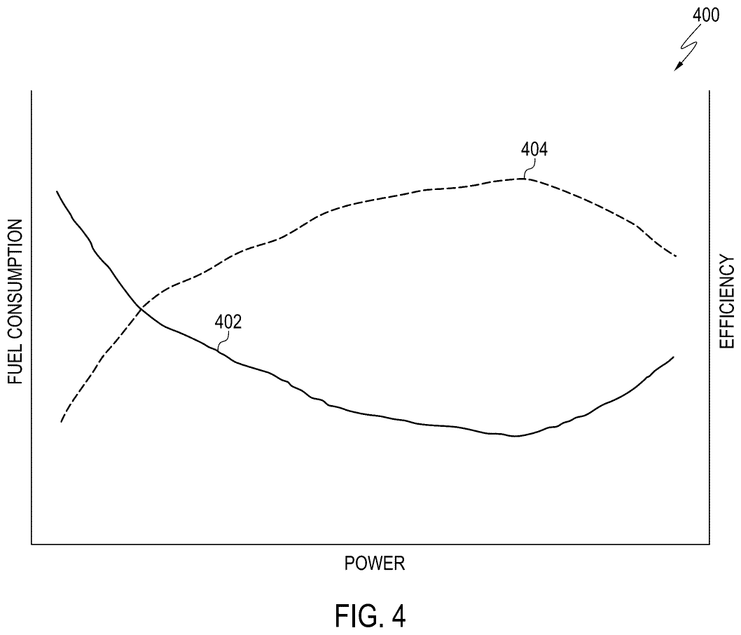

High efficiency operation of the engine at high power output also corresponds to increased fuel efficiency of the engine. As shown in FIG. 4, a graph 400 depicts a first plot 402 of fuel consumption relative to power output for the engine and a second plot 404 of engine efficiency, e.g., similar to the first plot 302 of FIG. 3. Fuel consumption at the engine increases upwards along the y-axis and power output increases to the right along the x-axis. The second plot 404 shows engine efficiency peaking when fuel consumption is lowest. When fuel consumption is lowered, emissions resulting from combustion of fuel may also be reduced.

For either of the engine and the fuel cell, operation at different loads may be requested based on a notch setting of a throttle, as described herein. As the notch setting is increased, higher power output is demanded from the power systems of the consist where power outputs of each of the power systems may be varied according to the demand. For the battery, as described above, the power output is set by the discharge rate of the battery. Without constraining the discharge (and charging) rate of the battery, high power demands may lead to increases in the discharge rate and frequency at which the battery is charged and discharged. Faster discharge rates, such as greater than about 1 C, and increased cycling of the battery may accelerate loss of capacity and degrade battery performance. However, the battery may be discharged at a high rate temporarily during operational changes of the power system. For example, the rate at which an operating mode of a power system must change to meet changes in workload may be relatively abrupt in comparison to fuel system operations such that changes in operating modes for the fuel supply system and the power system may be associated with different time scales.

In one embodiment, the power demand, as indicated based on the notch setting, may be divided evenly amongst the prime movers by the control circuit(s). For example, when the consist includes the engine, the battery, and the fuel cell and the overall vehicle group power demand is 9000 hp, each of the power systems may contribute a power output providing 3000 hp per system, for a total of 9000 hp. The even division of the power demand may result in one of the power providers operating below its maximum efficiency range, operating above its maximum efficiency range, and/or discharging and/or cycling at a fast rate. In addition to reduced operating efficiencies of the engine and fuel cell, degradation of the fuel cell and the battery may be expedited, fuel efficiency may be reduced, and carbon-based emissions may be increased.

In an alternate embodiment, as described herein, power output from each of the power systems may be strategically coordinated to operate each prime mover within their respective high efficiency ranges as well as reducing cycling of the battery and maintaining the battery discharge rate below a threshold discharge rate. For example, an imposed load (e.g., a power demand) as commanded by the transportation control system may be unevenly distributed across the power systems according to their respective optimal operating settings. For a high power demand/high load, such as above 1500 hp when the locomotive has a power rating of 4500 hp and includes a large engine and smaller, supporting prime movers, a large proportion (e.g., more than a third) of the load may be directed to the engine, thus operating the engine within its high efficiency range, as shown in FIG. 4. A smaller proportion of the load may be directed to the supporting prime movers, e.g., the fuel cell, allowing the fuel cell to operate within its high efficiency range. If the power output provided by high efficiency operation of the fuel cell does not satisfy the power demand, supplemental power may be drawn from another prime mover, which may allow the discharge rate to remain below the threshold discharge rate. Alternatively, if the power demand is initially satisfied by one or more fuel cells, the power demand may initially be satisfied by operating each fuel cell in the respective high efficiency range, and if the power demand is not satisfied, a new prime mover may be activated or provided fuel provided that each operating fuel cell is operating at or near a top end of its high efficiency range.

A division of power amongst the power generators in response to a high demand for power may be controlled or varied by one or more of the control circuits and/or the transportation control system depending on a configuration of the power systems onboard the locomotive. As described above, the engine may receive a larger proportion of the load when the engine is the largest power generator onboard the locomotive. In other examples, however, a primary power generator, e.g., the power device used predominantly for a specific locomotive power configuration, may not receive the largest proportion of the load and a remaining, unmet portion of the power demand may be addressed by the other, supporting power generators. For example, the primary power generator may be the fuel cell, in a fuel cell locomotive, that includes the engine for support and also draws power from the battery for supplemental power. The largest proportion of the load may be directed to the engine upon fulfilling a target power output from the fuel cell despite a primary role of the fuel cell. As another example, the locomotive may be a battery locomotive where the battery may have a high power rating, e.g., relative to an engine located on another locomotive of the consist, and a large proportion of the power demand may be met by the battery with support from power devices on other locomotives.

At lower aggregate power demands/loads, e.g., loads lower than 1500 hp, as an example, operation of the fuel cell at its optimal efficiency range may be prioritized by the power control circuit. Power delivered from the fuel cell may be supplemented by power from another prime mover, one or more of another fuel cell, the engine, and/or the battery while maintaining operating parameters of each of the engine and the battery within target settings. For example, if the engine is a multifuel engine configured to combust a primary, carbon-based fuel and a secondary, noncarbon fuel, a target setting for the multi-fuel engine may include maintaining a high substitution rate (e.g., substitution of the secondary fuel for the primary fuel) of a combusted fuel mixture. A target setting for the battery may be determined by the discharge rate, such as maintaining the discharge below 1 C. A magnitude of the discharge rate may be selected based on the power shortfall addressed by the battery, given that the battery can be discharged at a rate below the threshold discharge rate. Other conditions of the power systems, such as an age, history of cycling frequency of the battery, anticipated availability of charging events (e.g., according to a planned route), and a duty cycle, age, maximum power rating, expected availability of charging stations (e.g., according to the planned route) of the fuel cell, may affect distribution of the power demand amongst the power systems.

As described hereinabove, the transportation control system may determine and/or forecast a supply status of the fuel supply system based on fuel parameters and determine an energy plan therefrom which may dictate a workload and/or distribution thereof to be met by the power systems. In an embodiment, the transportation control system may determine a fuel parameter associated with executing an operation of a cryogenic fuel supply that feeds a power generator which may be based on data received from the fuel control circuit and/or the power control circuit. For example, the transportation control system may determine an expected fuel need by a prime mover for an operation thereof during a trip based on one or more forecasted travel parameters and determine a duration of time required to transition fuel at a first state to a second state to meet the expected fuel need.

As used herein, the term “transition time” may refer to this determined duration of time to transition the fuel. The transportation control system may offset an initiation of a transition in response to the determined fuel need to better align the reaching of the second state with the expected operation. Additionally, the transportation control system may command an increase or decrease in a rate of transition to adjust the transition time in response to the determined fuel need. These timing operations can be particularly useful when utilizing pressure driven flows from a cryogenic fuel system as the response time thereof may be limited by the rate at which the fuel operation unit can transition the fuel, which may be significantly greater than the response time required of a prime mover when switching operating modes.

When an increase in aggregate power demand is expected, the transportation control system may dictate an increase in fuel supply storage volume pressure and/or an increase in rate of fuel vaporization in order to meet the increased power demand, which may be initiated prior to the expected time at which increased power output is required to avoid overloading a heating capacity of the fuel operation unit and/or failing to meet the determined fuel need of the prime mover. Conversely, when a decrease in aggregate demand is expected, such as when approaching a known speed restricted portion of the route, the transportation control system may determine a depressurization rate to target via cooling the fuel supply and a time at which ramp down of fuel supply pressure should begin to meet the speed reduction and/or avoid overloading the cryogenic cooling system of the fuel supply system. Accordingly, the transportation control system may balance any discrepancy in time scales associated with fuel supply operations and power generator operations.

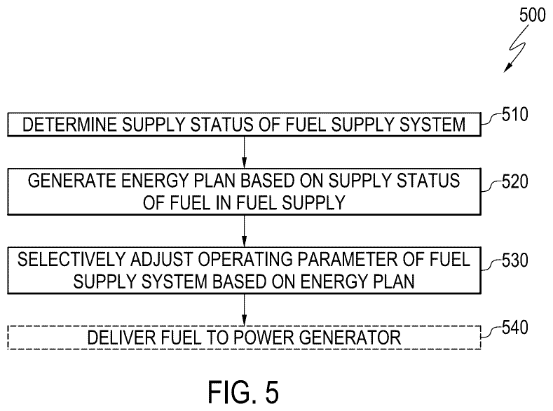

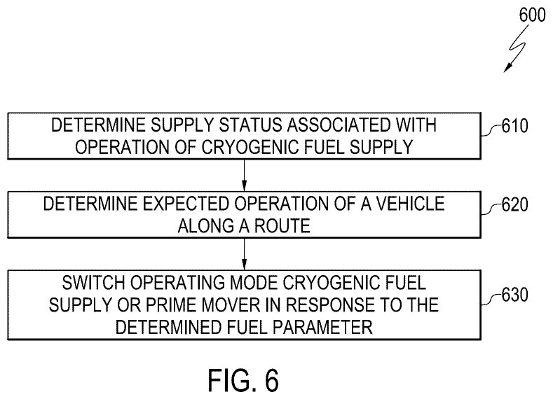

Any of these situational adjustments to fuel supply system operations may be incorporated into the energy plan and may be modified over the course of the trip based on changes in route conditions. Additionally, the energy plan may dictate adjustments to the power systems based at least in part on the supply status of the fuel supply system. In an embodiment, the transportation control system may cause an adjustment to workload based on a determined fuel parameter, such as, for example, lowering an aggregate power demand based on a maximum available flow capacity of a fuel supply system being insufficient for maintaining the fuel need of a power generator to meet the original workload at a given operating efficiency. As stated above, the rate at which an operating mode of a power system must change to meet changes in workload may be relatively abrupt in comparison to fuel system operations such that changes in operating modes for the fuel supply system and the power system may be associated with different time scales. Thus, the transportation control system may balance the requirements of a power generator with the capacity of a fuel system to optimize power delivery. Methods for operating various systems of a transportation system platform, such as those described hereinabove, are depicted in FIGS. 5-6.

FIG. 5 is a flow diagram of a method 500, which may be implemented with a fuel supply system and a power generator which store at least a cryogenic fuel and handle gasified fuel obtained from the cryogenic fuel. The method can include determining 510 a supply status of the fuel supply system for delivering fuel to the power generator, generating 520 an energy plan based at least in part on a supply status of fuel in the fuel supply system, and selectively adjusting 530 an operating parameter of the fuel supply system based at least in part on the energy plan. The operating parameter of the fuel supply system may be a pressurization rate, a vaporization rate, a heat transfer flow rate, a flow control operation, a regasification rate, a recirculation rate, a recondensation rate, or a combination of two or more thereof. The method may include delivering 540 fuel to the power generator. The fuel supply system can include a storage volume for storing cryogenic fuel such as liquefied hydrogen, a fuel operation unit for pressurizing, vaporizing and/or gasifying at least a portion of the cryogenic fuel within the storage volume, and may include one or more additional storage volumes and/or fuel operation units. Each of these portions of the fuel supply system may have respective process conditions and/or operating parameters. Additionally, the power generator may be one of a plurality of prime movers. Thus, the fuel supply system may be operated to selectively deliver fuel to one of multiple prime movers according as discussed in further detail below.

Determining the supply status may include determining a fuel supply variable indicative of an amount or a state of fuel within a determined portion of the fuel supply system, which may include measuring a pressure and/or a temperature within the determined portion. Determining the fuel supply variable may include determining an amount of liquid fuel within a storage volume of the fuel supply system and/or determining an amount of gaseous fuel available for use as a volume, a weight and/or an energy content of gaseous fuel based on one or both of an amount of liquid fuel and a pressure of a gaseous fuel. The amount of gaseous fuel available may be indicative of an amount of fuel suitable for consumption by a power generator at a given rate, or an amount of fuel which may be readily gasified or vaporized based at least in part on an amount of stored energy readily usable by the fuel supply system, particularly by the fuel operation unit.

Further to the above, the method may include delivering 550 fuel to the power generator. The fuel may include a portion of the amount of gaseous fuel available and delivered to the power generator as a pressure driven flow. The pressure driven flow may be obtained by heating the fuel such that the pressure thereof is elevated above the pressure of the storage volume and reintroducing the pressurized fuel into the storage volume. Accordingly, the method may deliver gasified fuel to the power generator from stored cryogenic fuel without the use of a cryogenic pump, thereby optimizing reliability of the fuel supply system.

Additionally, the supply status can be at least one of a current status or a forecasted status and may include one or more of a fuel supply status, a pressure of a gaseous fuel in a portion of the fuel system, or a fuel consumption rate. Thus, in this embodiment, the method may selectively adjust an operation of the fuel supply system to reach operating conditions such that the fuel supply system is prepared to deliver fuel to the power generator at a current and/or forecasted time or place according to the energy plan.

Additionally, determining the supply status may include determining a remaining lifetime of cryogenic fuel stored within the storage volume based at least in part on one or more of a current operating pressure of the fuel supply system, a current consumption rate of fuel by the power generator, a forecast consumption rate of fuel by the power generator, or a venting pressure of the fuel supply system. The method may further include feeding fuel from the storage volume to an auxiliary fuel converter based on the current operating pressure exceeding a determined threshold associated with the venting pressure.

The power generator may be one of a plurality of prime movers and accordingly, the energy plan may include a workload distribution between each of the plurality of prime movers, based at least in part on at least one of an aggregate power or an aggregate energy output. Each prime mover may be a fuel cell and the method may include operating each fuel cell in a determined range of efficiency, as demand for aggregate power or aggregate energy increases. A new prime mover may not be activated and/or provided fuel until each operating prime mover is operating at or near a top end of its determined range of efficiency, and once an additional prime mover is brought online, one or more of the operating prime movers may be adjusted to a lower end of their determined range of efficiency. The method may further include adjusting a first operating parameter and a second operating parameter, each for the fuel supply system, based at least in part on the workload distribution. The first operating parameter may be associated with a first storage volume of the fuel supply system configured to feed fuel to a first prime mover and the second operating parameter may be associated with a second storage volume of the fuel supply system configured to feed fuel to a second prime mover.

FIG. 6 provides a flow diagram of a method 600 in accordance with another embodiment of the present disclosure. In this embodiment, the method may include determining 610 a fuel parameter that is associated with an operation of a cryogenic fuel supply configured to feed a prime mover of a vehicle, determining 620 an expected operation of a vehicle along a route, and switching 630 an operating mode of at least one of the cryogenic fuel supply or the prime mover in response to the determined fuel parameter.

The expected operation of a vehicle along the route may also include a determined fuel need by the prime mover associated with the expected operation as the vehicle traverses the route. For example, the expected operation of the vehicle may include meeting at least a portion of an aggregate power demand and the fuel need associated therewith determined based on known or readily accessible travel factors, such as, geographical route features including grade and elevation, speed restrictions, weight restrictions, conditions of travel surfaces such as track sections, and other factors such as vehicle weight, vehicle cargo, or a quantity of separate vehicles relying on the vehicle for propulsion. An operation of the cryogenic fuel supply may include transitioning the state of fuel therein in order to meet, or prepare to meet, a determined fuel need or an expected change therein while traversing the route. Additionally, fuel needs along the route may be determined based on less predictable travel factors such unforeseen changes in weather conditions. However, as discussed elsewhere in the present disclosure, the feasibility of affecting operational changes based on these less predictable travel factors may be limited with respect to how far in advance a change can be anticipated due to increased forecasting uncertainty. Thus, some determined fuel needs may not be planned and whether or not they may be feasibly satisfied may rely on the determined fuel parameter as discussed in greater detail below.

When the operation of the cryogenic fuel supply involves transitioning the fuel from a first state to a second state, such as from a first temperature and pressure to a second temperature and pressure and/or from a liquid to a gas, determining the fuel parameter associated with the operation of the cryogenic fuel supply may include determining a duration of time required to effect the transition of the fuel from the first state to the second state and switching may include increasing or decreasing a rate of transition in response to the determined fuel need.

When a fuel transition is based on an expected operational change, such as an expected change in workload of a prime mover during a trip, or is otherwise determined when travel factors are known and/or highly forecastable, such as at confidence levels of greater than 95%, the transition time can be determined with a high degree of accuracy and may be referred to as being static, or about static when determined to be within a specific tolerance of time, such as +/−5 minutes. When the transition time is static or about static, switching the operating mode of at least one of the cryogenic fuel supply or the prime mover in response to the determined fuel parameter can include offsetting a timing or initiation of the transition to meet an expected increase or decrease in fuel required by the prime mover along the route, and may include offsetting the timing of the transition by the value of the transition time and any range associated therewith. Accordingly, the method may minimize any discrepancy between the response time involved with operating the cryogenic fuel supply and the response time required by the prime mover when changing power levels or maintaining a power level with changing route conditions, without consuming excessive amounts of energy to maintain the fuel supply at a ready state when not required to do so.

The terms “processor” and “computer,” and related terms, e.g., “processing device,” “computing device,” “controller,” “control circuit,” ”and may be not limited to just those integrated circuits referred to in the art as a computer, but refer to a microcontroller, a microcomputer, a programmable logic controller (PLC), field programmable gate array, and application specific integrated circuit, and other programmable circuits. Suitable memory may include, for example, a computer-readable medium. Any programmed or programmable electronic device that can store, retrieve, and process data.

The term “software” or “computer program” as used herein includes, may include but is not limited to, one or more computer readable and/or executable instructions that cause a computer or other electronic device to perform functions, actions, and/or behave in a desired manner. The instructions may be embodied in various forms such as routines, algorithms, modules or programs including separate applications or code from dynamically linked libraries. Software may also be implemented in various forms such as a stand-alone program, a function call, a servlet, an applet, an application, instructions stored in a memory, part of an operating system or other type of executable instructions.

A computer-readable medium may be, for example, a random-access memory (RAM), a computer-readable non-volatile medium, such as a flash memory. The term “non-transitory computer-readable media” represents a tangible computer-based device implemented for short-term and long-term storage of information, such as, computer-readable instructions, data structures, program modules and sub-modules, or other data in any device. Therefore, the methods described herein may be encoded as executable instructions embodied in a tangible, non-transitory, computer-readable medium, including, without limitation, a storage device and/or a memory device. Such instructions, when executed by a processor, cause the processor to perform at least a portion of the methods described herein. As such, the term includes tangible, computer-readable media, including, without limitation, non-transitory computer storage devices, including without limitation, volatile and non-volatile media, and removable and non-removable media such as firmware, physical and virtual storage, CD-ROMS, DVDs, and other digital sources, such as a network or the Internet. The “non-transitory computer-readable media” may include, but not limited to, a CD-ROM, a removable flash memory card, a hard disk drive, a magnetic tape, and a floppy disk. The “memory” or “computer memory”, may refers to a storage device configured to store digital data or information which can be retrieved by a computer or processing element.

The foregoing description presents various embodiments of systems and processes through block diagrams, flowcharts, and examples. Each of the depicted components, functions, or operations may be implemented using hardware, software, firmware, or combinations thereof. Specific features can be executed using integrated circuits, computer programs, or processors (e.g., microprocessors, microcontrollers), as well as other software-hardware combinations. The design and development of such implementations, whether via circuitry or software, are within the technical expertise of those skilled in the art. Moreover, the described methods and mechanisms may be distributed as program products on various media, with no restriction on the format of the medium.

Instructions for implementing these features can be stored in various types of memory, including dynamic random-access memory (DRAM), flash memory, and/or cache. These instructions can also be distributed over a network or via other computer-readable media. The term “non-transitory computer-readable medium” refers to any physical medium capable of storing or transmitting instructions or information that can be read by a machine. Examples include, but are not limited to, optical disks, CD-ROMs, RAM, ROM, EPROM, EEPROM, magnetic or optical cards, flash memory, or even propagated signals such as carrier waves or infrared signals.

software components described herein may be implemented using languages such as Python, Java, C++, or Perl. The corresponding software code may be stored on various computer-readable media, such as RAM, ROM, hard drives, or CD-ROMs. These media may be part of a single computational device or distributed across multiple devices within a networked system.

The term “control circuit” encompasses hardwired circuitry, programmable logic (such as microprocessors, microcontrollers, digital signal processors (DSPs), programmable logic devices (PLDs), programmable gate arrays (PGAs), or field-programmable gate arrays (FPGAs)), state machines, or firmware that executes stored instructions. Control circuits may form part of larger systems, such as integrated circuits (ICs), application-specific integrated circuits (ASICs), or systems-on-chips (SoCs), and are commonly found in devices such as computers, smartphones, and servers. These circuits may perform tasks involving data processing, communication, or data storage.

In some embodiments, the control circuit can utilize machine learning (ML) techniques to make decisions based on sensor inputs or other data. ML methods may include supervised learning (with labeled inputs and outputs), unsupervised learning (for identifying patterns), or reinforcement learning (where the system adapts based on feedback). tasks for ML systems may involve classification, regression, clustering, anomaly detection, or optimization, with algorithms such as decision trees, deep learning, support vector machines (SVMs), or neural networks being employed, depending on the application.

A control circuit may also incorporate a policy engine that applies specific rules based on equipment characteristics or environmental conditions. For instance, a neural network could process sensor data or operational inputs to determine appropriate actions. techniques such as backpropagation or evolutionary strategies may be used to refine neural network parameters and optimize model selection for the given task.

The system may handle data generation, transmission, and storage, potentially leveraging both protected and exposed data sources. Encryption and decryption can be applied during data transit, at rest, or in use, with keys and schemas determined based on operational needs. The control circuit may monitor and enforce decision boundaries, ensuring that data from protected sources meets safety or operational thresholds. If data breaches these boundaries, the system may initiate actions such as equipment shutdown, component isolation, or transitioning to safe mode to mitigate potential risks or damages.

In one embodiment, the control circuit, controller, and systems described herein may use machine learning to make determinations and to enable derivation-based learning outcomes. The system may communicate with a data collection system. The control circuit may learn from, model and make decisions/determinations on a set of data (including data provided by various sensors and data collection systems) by making data-driven predictions and adapting according to available data and modeling. Machine learning may involve performing tasks using supervised learning, unsupervised learning, and reinforcement learning systems. Supervised learning may use a set of example inputs and desired outputs to the machine learning systems, where unsupervised learning may use a learning algorithm that is structuring its input with, e.g., pattern detection and/or feature learning. Reinforcement learning may perform in a dynamic environment and then provide feedback about correct and incorrect decisions. Machine learning may include tasks based on certain outputs. These tasks may be machine learning problems such as classification, regression, clustering, density estimation, dimensionality reduction, anomaly detection, and the like to include other mathematical and statistical techniques. Suitable machine learning algorithmic types may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used for making determinations, calculations, comparisons and behavior analytics, and the like.

In one embodiment, the control circuit may include a policy engine. The policies the engine may apply can be based at least in part on characteristics of a given item of equipment or environment. For example, an artificial intelligence system, such as a neural network, can receive input of a number of environmental and task-related parameters. These parameters may include, for example, operational input of the given equipment, data from various sensors, environmental information, location and/or position data, and the like. The neural network can be trained and can generate an output based on these inputs, with the output representing an action or sequence of actions that the equipment or system should take to accomplish the goal of the operation. The control circuit can process the inputs through the parameters of the neural network to generate a value (i.e., make a determination) at the output node designating that action as the desired action, activity, or operating state. An action may translate into a signal that causes the vehicle to operate in a particular manner. The control circuit may accomplish this via back-propagation, feed forward processes, closed loop feedback, or open loop feedback, for example. Alternatively, rather than using backpropagation, the control circuit may use evolution strategies techniques to tune various parameters of the neural network. The control circuit may use neural network architectures that have a set of parameters representing weights of its node connections. A number of copies of this network can be generated and adjustments to the parameters can be made with subsequent simulations. Once the outputs from the various models have been obtained, they may be evaluated on their performance using a determined success metric. The best model is selected, and the control circuit can execute that plan to achieve the desired input data to mirror the predicted best outcome scenario. Additionally, the success metric itself may be a combination of the optimized outcomes, which may be weighed relative to each other. Success metrics may be dynamically established, and the process rerun and the equipment directions further modified.

In one embodiment, data can be generated, transmitted, and stored and may involve one or both of a protected space data source and the exposed space data source. The control circuit may encrypt and decrypt data as needed at rest, during use, or in transit. Encryption keys and schema may be selected and implemented as informed by end use parameters and requirements. The control circuit may evaluate and/or identify a decision boundary (that is, a boundary that separates desired behavior from undesired behavior) with regard to that data. If the control circuit determines that some quantity of data is from a protected space data source and/or is operating within determined boundaries then the control circuit, and the equipment being controlled, may operate normally. However, if the data is determined to be from an exposed space data source and/or it crosses the decision boundary, the control circuit may respond. Suitable responses may be to power down determined equipment, signal an alert, run a diagnostic routine, perform a data backup (without overwriting existing backup data), isolate equipment (including by suspending some or all communication pathways), switch equipment or control operations to a safe mode of the control system, and/or initiate a safe mode state of the equipment (e.g., slow a vehicle to a safe and controlled stop). The safe mode may be, in one embodiment, a soft shutdown mode that it intended to avoid damage or injury based on the shutdown itself and in another embodiment may be a reboot and/or minimal reload of essential drivers and functionality.

The term “logic” refers to software, firmware, and/or circuitry configured to execute the described operations. Logic may be implemented as applications, software packages, instruction sets, or data stored on non-transitory computer-readable storage media. Firmware may be hard-coded into memory devices. Components and modules described herein may be hardware, software, or a combination thereof, and may be in active, inactive, or standby states depending on system requirements.

An “algorithm” refers to a sequence of steps designed to achieve a specific result. These steps may manipulate physical quantities, typically in the form of electrical or magnetic signals, which are represented as bits, values, symbols, or numbers. The terms used to describe these processes are labels for the underlying physical operations.

The system may operate over a packet-switched network using various communication protocols, including Ethernet (complying with IEEE 802.3 standards), X.25, frame relay, or Asynchronous Transfer Mode (ATM). Communication between devices may follow established protocols such as TCP/IP or new emerging standards.

Terms such as “processing,” “computing,” “calculating,” or “determining” refer to operations carried out by computing systems or electronic devices, which manipulate data represented as physical (electronic) quantities within memory or registers.

Terms like “component,” “system,” and “module” refer to computer-related entities, whether hardware, software, or a combination thereof. One or more components may be described as “configured to,” “configurable to,” “operable/operative to,” “adapted/adaptable to,” or similar terms. Unless explicitly stated, these terms encompass components in both active and inactive states.

Unless stated otherwise, terms like “including” or “having” should be interpreted as open-ended (i.e., “including but not limited to”). Numeric claim recitations generally mean “at least” the stated number, and disjunctive terms like “A or B” should be interpreted to include either or both unless explicitly specified. Operations in any claim may generally be performed in any order unless explicitly stated. The recitation “at least one of A, B, and C” should be interpreted as any combination of A, B, and C, such A alone, B alone, C alone, A and B together, A and C together, B and C together, and/or A, B, and C together. The recitation “at least one of A, B, or C” should be interpreted to include A alone, B alone, C alone, A and B together, A and C together, B and C together, and/or A, B, and C together.

In summary, various embodiments have been described to illustrate the principles and applications of the disclosed systems and methods. These descriptions are not intended to limit the scope of the invention, and variations may be made by those skilled in the art. The accompanying claims define the invention's broadest legal scope within its spirit and scope.

Use of phrases such as “one or more of . . . and,” “one or more of . . . or,” “at least one of . . . and,” and “at least one of . . . or” are meant to encompass including only a single one of the items used in connection with the phrase, at least one of each one of the items used in connection with the phrase, or multiple ones of any or each of the items used in connection with the phrase. For example, “one or more of A, B, and C,” “one or more of A, B, or C,” “at least one of A, B, and C,” and “at least one of A, B, or C” each can mean (1) at least one A, (2) at least one B, (3) at least one C, (4) at least one A and at least one B, (5) at least one A, at least one B, and at least one C, (6) at least one B and at least one C, or (7) at least one A and at least one C.

The singular forms “a”, “an”, and “the” include plural references unless the context clearly dictates otherwise. “Optional” or “optionally” means that the subsequently described event or circumstance may or may not occur, and that the description may include instances where the event occurs and instances where it does not. Approximating language, as used herein throughout the specification and claims, may be applied to modify any quantitative representation that could permissibly vary without resulting in a change in the basic function to which it may be related. Accordingly, a value modified by a term or terms, such as “about,” “substantially,” and “approximately,” may be not to be limited to the precise value specified. In at least some instances, the approximating language may correspond to the precision of an instrument for measuring the value. Here and throughout the specification and claims, range limitations may be combined and/or interchanged, such ranges may be identified and include all the sub-ranges contained therein unless context or language indicates otherwise.

This written description uses examples to disclose the examples, including the best mode, and to enable a person of ordinary skill in the art to practice the examples, including making and using any devices or systems and performing any incorporated methods. The claims define the patentable scope of the disclosure and include other examples that occur to those of ordinary skill in the art. Such other examples are within the scope of the claims if they have structural elements that do not differ from the literal language of the claims, or if they include equivalent structural elements with insubstantial differences from the literal language of the claims.

What is claimed is:

1. A method, comprising:
determining a supply status of a fuel supply system that is configured to deliver fuel from a fuel storage to a power generator;
generating an energy plan for the power generator based at least in part on the supply status; and
selectively adjusting an operating parameter of the fuel supply system based at least in part on the energy plan.

2. The method of claim 1, wherein determining a supply status comprises measuring a pressure, a temperature, or both within the fuel storage.

3. The method of claim 1, wherein determining a supply status comprises determining an amount of liquid fuel within the fuel storage.

4. The method of claim 1, wherein determining the supply status comprises determining an amount of gaseous fuel available, as a volume, weight or energy content of fuel based on one or both of an amount of liquid fuel and a pressure of a gaseous fuel.

5. The method of claim 1, wherein the supply status comprises at least one of:
a current fuel supply status;
a forecasted fuel supply status;
a current pressure of a gaseous fuel fraction in the fuel storage;
a forecasted pressure of a gaseous fuel fraction in the fuel storage;
a current consumption rate of fuel by the power generator; or
a forecasted consumption rate of fuel by the power generator.

6. The method of claim 5, wherein determining the supply status comprises determining a remaining lifetime of fuel stored within the fuel storage of the fuel supply system based at least in part on one or more of:
a current operating pressure of the fuel supply system;
a forecast operating pressure of the fuel supply system;
a current consumption rate of fuel by the power generator;
a forecast consumption rate of fuel by the power generator; or
a venting pressure threshold of the fuel supply system.

7. The method of claim 5, further comprising feeding fuel from the fuel storage to an auxiliary fuel converter based on the supply status indicating a current operating pressure of the fuel supply system exceeds a determined pressure threshold value in the fuel storage.

8. The method of claim 5, further comprising feeding fuel from the fuel storage to an auxiliary fuel converter responsive to the supply status indicating a forecasted operating pressure of the fuel supply system exceeds a determined pressure threshold value in the fuel storage.

9. The method of claim 8, wherein feeding fuel from the fuel storage to an auxiliary fuel converter is further responsive to a state of charge of an electrical energy storage device.

10. The method of claim 1, wherein the operating parameter of the fuel supply system comprises a pressurization rate, a vaporization rate, a heat transfer flow rate, a flow control operation, a regasification rate, a recirculation rate, a recondensation rate, or a combination of two or more thereof.

11. The method of claim 1, wherein the power generator is one of a plurality of prime movers and the energy plan comprises a workload distribution between each of the plurality of prime movers, and the workload distribution is based at least in part on at least one of an aggregate power output or an aggregate energy output of the plurality of prime movers.

12. The method of claim 11, further comprising:
adjusting the operating parameter for feeding fuel from the fuel storage to a first prime mover and to a second prime mover of the plurality of prime movers; and
the operating parameter is adjusted based at least in part on the workload distribution.

13. The method of claim 11, wherein each prime mover is a fuel cell, and the method comprises operating each fuel cell in a determined range of efficiency, as demand for aggregate power or aggregate energy increases, a new prime mover is not activated or provided fuel until each operating prime mover is operating at or near a top end of its determined range of efficiency.

14. The method of claim 13, wherein, in response to bringing an additional prime mover online, all of the operating prime movers are adjusted to the lower end of their determined range of efficiency.

15. A method, comprising:
determining a supply status that is associated with an operation of a cryogenic fuel supply that is configured to feed a prime mover of a vehicle;
determining an expected operation of the vehicle along a route, and a determined fuel need by the prime mover associated with the expected operation as the vehicle traverses the route; and
switching an operating mode of at least one of the cryogenic fuel supply or the prime mover in response to the determined supply status.

16. The method of claim 15, wherein determining the supply status comprises obtaining a transition time of fuel from a first state and a second state, and switching comprises increasing or decreasing a rate of transition of fuel in response to the determined fuel need.

17. The method of claim 15, wherein a transition time of fuel from a first state and a second state is about static, and switching comprises offsetting an initiation of the transition to meet an expected increase or decrease in determined fuel need of the prime mover.

18. The method of claim 15, wherein a transition time of fuel from a first state and a second state is about static, and switching comprises reducing an expected power requirement from the prime mover.

19. A system for a vehicle having a power generator and a fuel supply system for delivering fuel to the power generator, comprising a control circuit that is configured to:
determine a forecasted supply status that is associated with an operation of the fuel supply system that is configured to feed the power generator;
determine an expected operation of the vehicle along a route;
determine a forecasted fuel need by the power generator associated with the expected operation as the vehicle traverses the route; and
switch an operating mode of the fuel supply system or the power generator in response to match the forecasted supply status with the forecasted fuel need.

20. The system of claim 19, wherein the fuel has an adjustable transition time from a first state and a second state, and the control circuit in switching the operating mode is further configured to, one or more of:
adjust the transition time of the fuel to adjust the transition time in response to the forecasted fuel need;
offset an initiation of a transition of the fuel in response to the forecasted fuel need;
reduce a power output of the power generator; or
reduce a speed of the vehicle.
